(19) United States
(12) Patent Application Publication
(10) Pub. No.: US 2010/0149634 A1
(43) Pub. Date: Jun. 17, 2010

(54) SIGHTING APPARATUS CAPABLE OF DISPLAYING MAGNIFICATION

(75) Inventors: CHIA-CHI TANG, Tantz Shiang (TW); Tung-ching Chen, Tantz Shiang (TW)

Correspondence Address: Flash Intellectual Property, Inc.;Attn. Cheng-Ju Chiang, P.O. Box 766, Chino, CA, 91708, US

(73) Assignee: ASIA OPTICAL CO., INC., Tantz Shiang (TW)

(21) Appl. No.: 12/573,082

(22) Filed: Oct. 2, 2009

(30) Foreign Application Priority Data
Dec. 12, 2008 (TW) 097148344

(51) Int. Cl. G02B 23/00

(52) U.S. Cl. 359/422

(57) ABSTRACT

Provided is a sighting apparatus capable of displaying a value of magnification. The sighting apparatus includes a magnification generation module, a controller and a display unit. The magnification generation module includes a magnification pattern, which contains multiple values of magnification, and a sensing unit. When the magnification pattern is rotated, the sensing unit detects one of the magnification values from the magnification pattern. The magnification generation module generates a magnification signal corresponding to the magnification value. The controller functions to transform the magnification signal and the display unit displays the value of magnification corresponding to the magnification signal.

### BACKGROUND OF THE INVENTION

1. Field of the Invention

The present invention relates to a sighting apparatus, and more particularly to a sighting apparatus that displays a value of magnification value in a field of vision of the sighting apparatus and is applicable to a laser sight and a rangefinder.

2. Description of the Prior Art

FIG. 1 of the attached drawings shows a schematic view of a conventional sighting apparatus, generally designated at 100. The conventional sighting apparatus 100 generally comprises a sighting tube 102, a magnification adjustment ring 104 and, an array of values of magnification 106. The magnification adjustment ring 104 is mounted on the sighting tube 102, serving as a rotary mechanism to be operated by a user to select and adjust the magnification value of the sighting apparatus 100. The magnification adjustment ring 104 is provided with indications showing multiple values of magnification, such 3, 4, . . . , 9, to serve an indication and selection by a user for setting the magnification of the sighting apparatus 100. To operate, the magnification adjustment ring 104 is rotated to change the magnification values 106 so that the user may visually identify the current value of magnification applied to the sighting apparatus 100. When a user sights at an instant target through the sighting tube 102, the user often adjusts the magnification at the same time when he or she is observing the instant target with the sighting tube 102 in order to correctly aim at the target. Under this situation, the user's eyesight must frequently leave the sighting tube 102 to visually check the magnification values 106 that are provided on the magnification adjustment ring 104 in order to get aware of the current magnification value of the sighting apparatus 100. This makes it difficult to precisely adjust the magnification adjustment ring 104 to the desired magnification value 106, and apparently, the operation is awkward. In view of this problem, it is desired to develop a novel sighting apparatus that overcomes the above described problem.

### BRIEF SUMMARY OF THE INVENTION

An object of the present invention is to provide a sighting apparatus, which is capable of immediately displaying the value of magnification in a field of vision of the sighting apparatus in order to eliminates the problem that a user must removes his or her eye from a field of vision of an existing sighting apparatus, whereby precision of sighting can be enhanced.

To achieve the above object, in accordance with the present invention, a sighting apparatus capable of displaying magnification is provided, comprising a magnification generation module, a controller, a display unit, and a magnification adjustment module. The sighting apparatus is mounted on a sighting tube. The magnification generation module is couple to the magnification adjustment module of the sighting apparatus. The magnification generation module comprises a magnification pattern and a sensing unit. The magnification pattern contains a plurality of values of magnification. When the magnification generation module is being adjusted, the magnification pattern undergoes a corresponding change of the magnification value in response to the adjustment of the magnification adjustment module, whereby the sensing unit detects the magnification pattern and obtains a current value of magnification among the magnification values. The sensing unit generates a magnification signal corresponding to the current magnification value. The controller transforms the magnification signal. The display unit receives the transformed magnification signal and displays the current magnification value. The magnification pattern comprises a plurality of magnification sections, each corresponding to one magnification value. The magnification pattern and the magnification adjustment module are set in synchronization with each other for the operations thereof.

In a first embodiment, each of the magnification sections comprises a plurality of electrode zones. The sensing unit comprises a plurality of electrically conductive portions and each electrically conductive portion is set in electrical engagement with a respective electrode zone of the magnification sections, whereby the electrically conductive portions detect the magnification signal. The magnification pattern is constructed as an electrically conductive ring.

In a second embodiment, each of the magnification sections comprises a plurality of light/shade areas. The sensing unit comprises a plurality of light detection elements. Each light detection area corresponds to a respective light/shade area of each magnification section, whereby the light detection elements detect the magnification signal. The magnification pattern is constructed as a disc-shaped layer of material. In a third embodiment, the magnification pattern is constructed as a rectangular layer of material forming a circumferential ring of patterns, wherein the light detection elements of the second embodiment may be employed to detect the light/shade areas of the rectangular layer of material.

Based on the above description, the sighting apparatus capable of displaying magnification as provided by the present invention comprises a magnification generation module that comprises a magnification pattern and a sensing unit. The sensing unit functions to detect the magnification pattern in order to obtain a current value of magnification among those magnification values for immediate display of the current magnification value in a field of vision of the sighting apparatus. In this way, the problem that a user must remove his or her eye from the field of vision of an existing sighting apparatus in order to get aware of the magnification value is completely overcome.

### BRIEF DESCRIPTION OF THE DRAWINGS

The present invention may best be understood through the following description with reference to the accompanying drawings, in which:

FIG. 1 is a schematic view illustrating a conventional sighting apparatus;

FIG. 2 is a cross-sectional view of a sighting apparatus capable of displaying magnification according to an embodiment of the present invention;

FIG. 3 is a schematic view illustrating a field of vision of the sighting apparatus of FIG. 2 according to the present invention;

FIG. 4 is a block diagram of the sighting apparatus capable of displaying magnification according to an embodiment of the present invention;

FIG. 5 is a schematic view showing a magnification pattern of a magnification generation module according to a first embodiment of the present invention;

FIG. 6A is a schematic view showing a magnification pattern of a magnification generation module according to a second embodiment of the present invention;

FIG. 6B is a schematic view of a sensing unit of the magnification generation module of FIG. 6A according to the present invention; and

FIG. 7 is a schematic view showing a magnification pattern of a magnification generation module according to a third embodiment of the present invention.

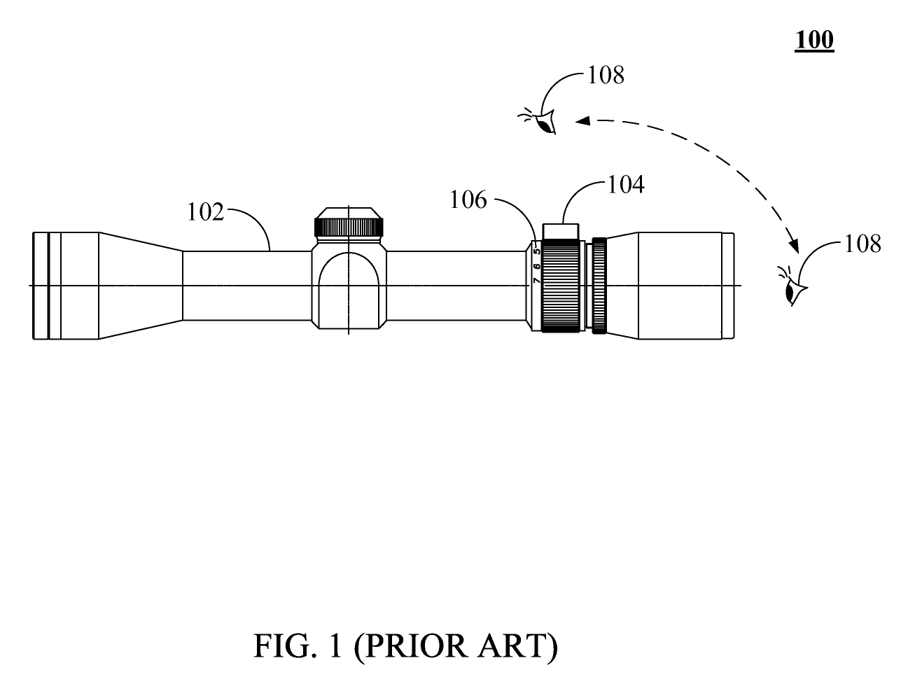

### DETAILED DESCRIPTION OF THE PREFERRED EMBODIMENTS

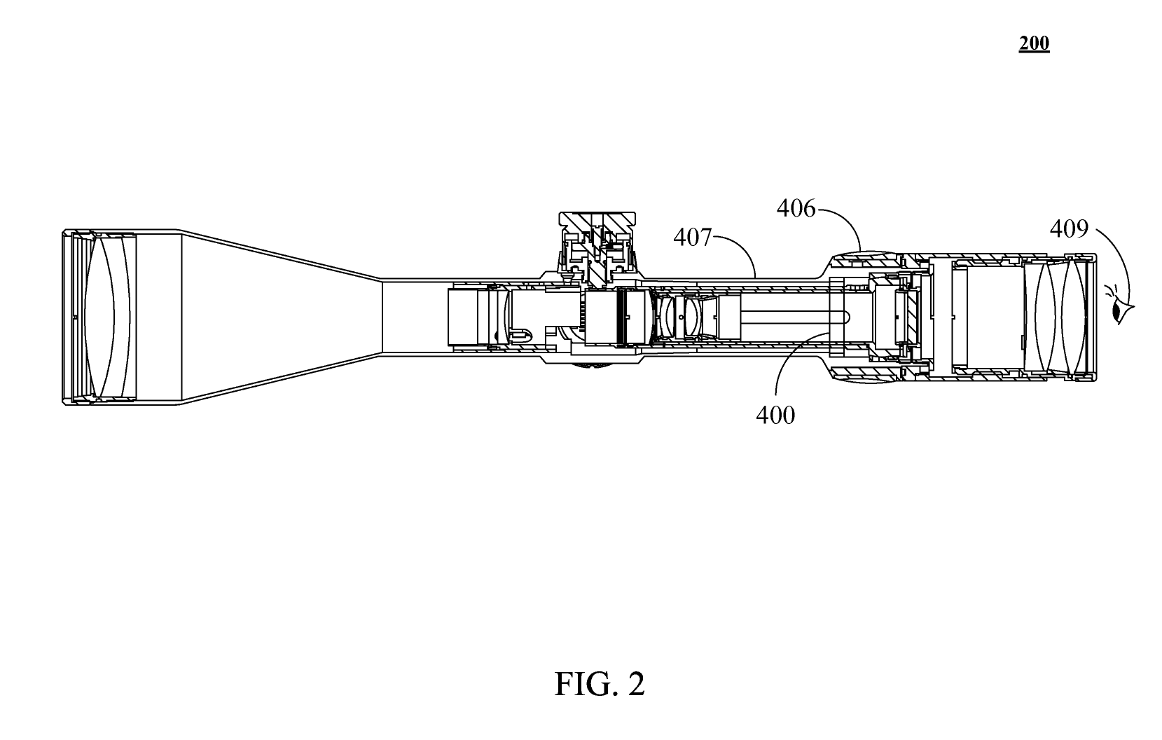

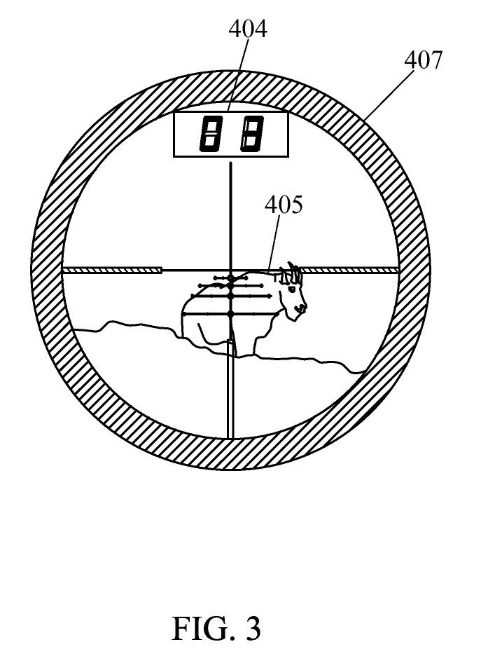

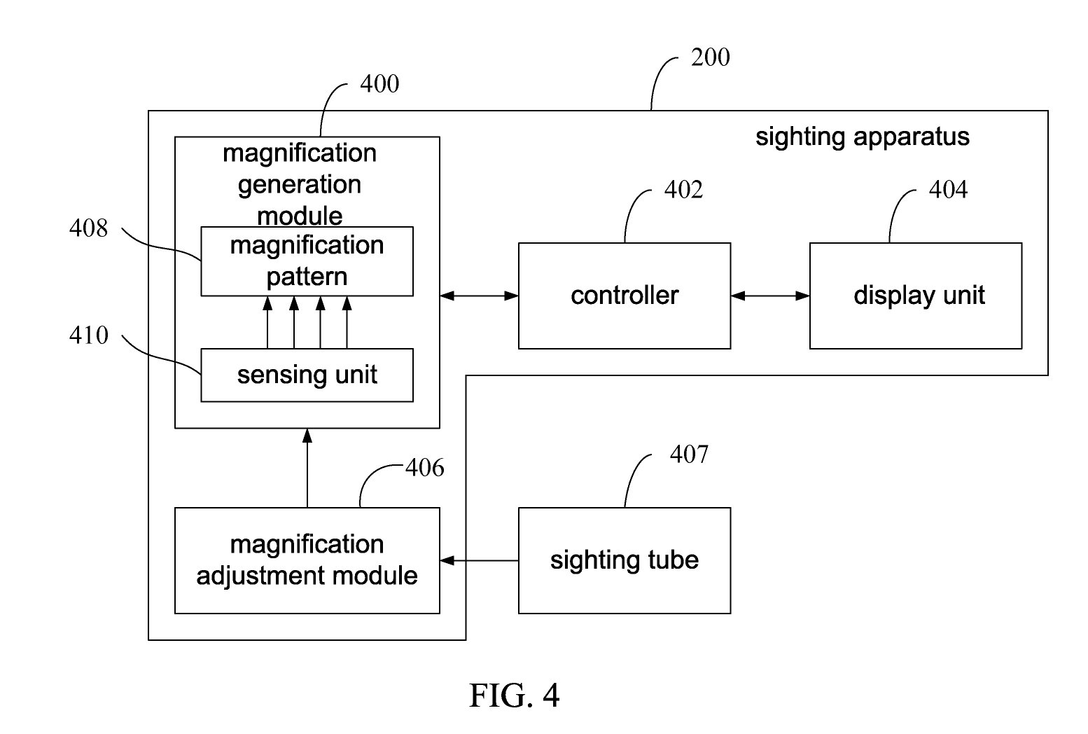

With reference to FIG. 2, which is a cross-sectional view of a sighting apparatus 200 capable of displaying magnification according to an embodiment of the present invention, and FIG. 3, which is a schematic view showing a field of vision sighted with the sighting apparatus 200 of the present invention shown in FIG. 2, the sighting apparatus 200 generally comprises a magnification generation module 400, a controller 402 (particularly shown in FIG. 4), a display unit 404 (particularly shown in FIG. 3), and a magnification adjustment module 406. The magnification adjustment module 406 is mounted on a sighting tube 407 to serve as a user operated adjustment measure for adjusting the value of magnification of the sighting apparatus 200. When the user's eye 409 sights a target 405, for example, a prey animal, the current value of magnification is simultaneously displayed in the field of vision of the sighting apparatus 200. Therefore, the problem that the user must remove his or her eye from the field of vision of an existing sighting apparatus before he or she can check the currently applied magnification can be overcome with the sighting apparatus 200 of the present invention and losing of sighting of the target due to the movement of eye is eliminated and aiming precision can be maintained and enhanced.

FIG. 4 is a block diagram of the sighting apparatus 200 capable of displaying magnification according to an embodiment of the present invention. The sighting apparatus 200 generally comprises a magnification generation module 400, a controller 402, a display unit 404, and a magnification adjustment module 406. The sighting apparatus 200 is mounted on a sighting tube 407. The magnification generation module 400 is coupled to the magnification adjustment module of the sighting apparatus 200 and the magnification generation module 400 comprises a magnification pattern 408 and a sensing unit 410. The magnification pattern 408 is composed of a plurality of values of magnification. When the magnification adjustment module 406 is operated for adjustment, the magnification pattern 408 is caused to move and thus change the value of magnification corresponding to the operation of the magnification adjustment module 406, and the magnification pattern 408 is then detected by the sensing unit 410 to retrieve the currently set value of magnification from the magnification pattern 408. The sensing unit 410 also generates a magnification signal corresponding to the current value of magnification. In one embodiment, the magnification adjustment module 406 is constructed for example as rotatable magnification adjustment ring encompassing an outer circumference of the sighting tube 407. To operate, the rotatable magnification adjustment ring is rotated to cause a change of the magnification of the sighting apparatus. The controller 402 is coupled to the magnification generation module 400 for transformation of the magnification signal. The display unit 404 is coupled to the controller 402 to receive the transformed magnification signal and display the current value of magnification.

In one embodiment, the controller 402 may be for example a micro control unit (MCU), a digital signal processor (DSP), a central processing unit (CPU), a complex programmable logic device (CPLD), a field programmable gate array (FPGA), or a system on-chip (SOP), or any combination thereof. The display unit 404 may be for example a seven-segment display consisting of light-emitting diodes (LEDs), a liquid crystal display, or any suitable displaying devices. In one embodiment, the seven-segment display may be for example directly disposed on an optical focal plane of the sighting apparatus 200, or alternatively, the value of magnification displayed by the seven-segment display is projected to the optical focal plane of the sighting apparatus 200 through reflection projection, to thereby become visible in the field of vision of the sighting apparatus 200 and be seen by the user.

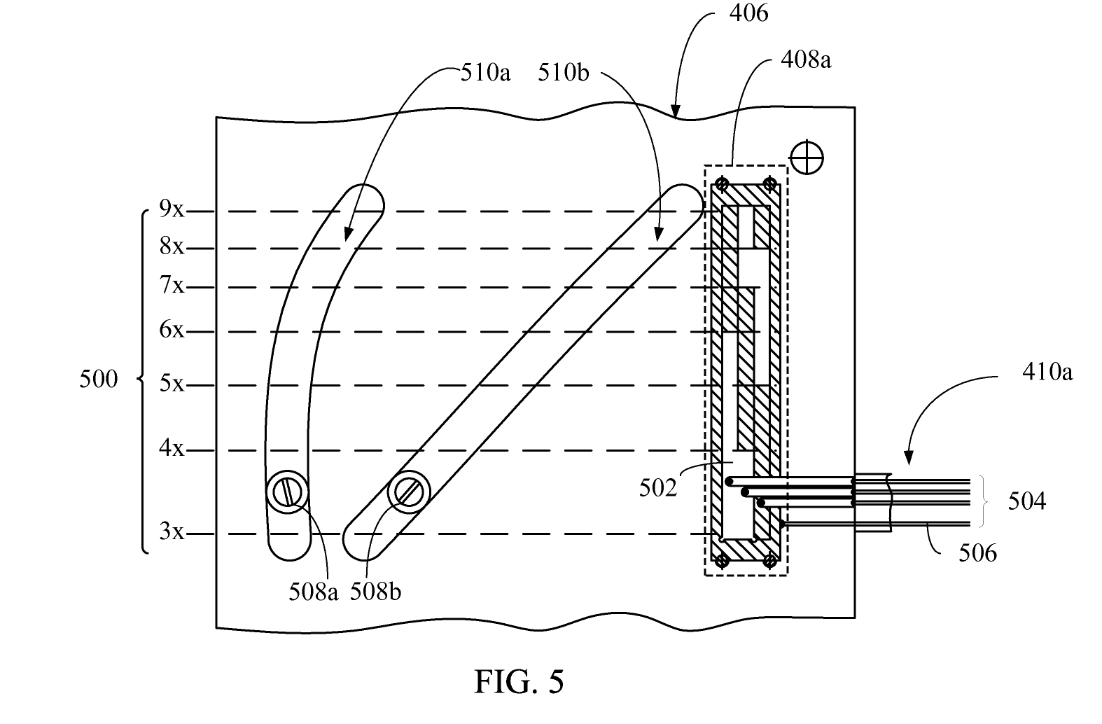

Referring to FIGS. 4 and 5, FIG. 5 is a schematic view of a magnification pattern 408a of the magnification generation module 400 according to a first embodiment of the present invention. The magnification pattern 408a is disposed in the magnification adjustment module 406. The magnification pattern 408a is composed of a plurality of magnification sections 500 and the magnification pattern 408a contains a plurality of values of magnification. Each magnification section 500 corresponds to one of the values of magnification. The magnification pattern 408a and the magnification adjustment module 406 are set in synchronization with each other for operation thereof. In an embodiment, each magnification section 500 includes a plurality of electrode zones 502 and the magnification pattern 408a is constructed as an electrically conductive ring, such as conductive metal ring.

A sensing unit 410a comprises a plurality of electrically conductive portions 504 and a grounding portion 506. Each conductive portion 504 is in electrical contact with one corresponding electrode zone 502 of each magnification section 500, respectively, whereby the electrode portions 504 can detect the magnification signal. With each conductive portion 504 electrically engages the respective electrode zone 502 of one magnification section 500, a detection voltage level is formed between each conductive portion 504 and the grounding portion 506, and the detection voltage levels are combined to form a magnification signal. In FIG. 5, the magnification pattern 408a contains seven magnification sections respectively representing a value of magnification from 3× to 9×.

In an embodiment, the sighting apparatus 200 comprises a first positioning dowel 508a and a second positioning dowel 508b, which are separately coupled to lens groups. With the magnification adjustment module 406 being embodied as a rotatable magnification adjustment ring, a first guiding groove 510a and a second guiding groove 510b are formed in the rotatable magnification adjustment ring and respectively receive the first positioning dowel 508a and the second positioning dowel 508b therein. When the rotatable magnification adjustment ring is rotated, the first guiding groove 510a and the second guiding groove 510b respectively guide movements of the first positioning dowel 508a and the second positioning dowel 508b to cause change of spacing between the two lens groups for realizing change of magnification.

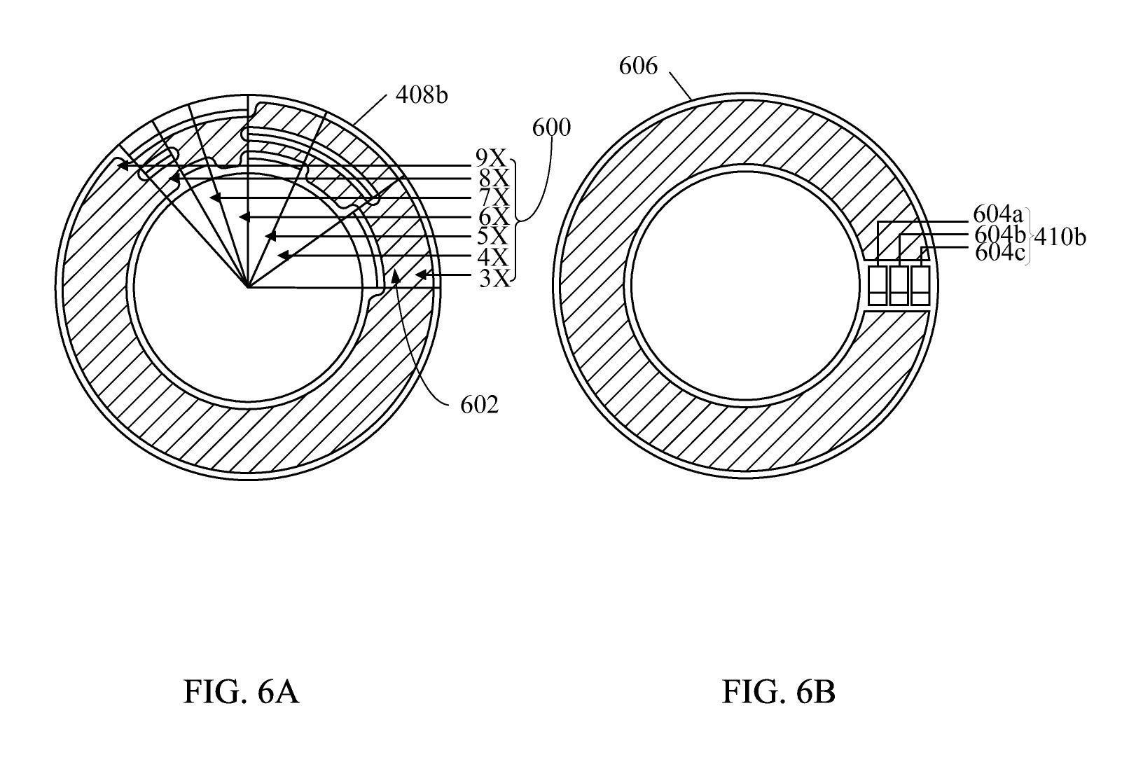

Referring to FIGS. 4, 6A and 6B, FIG. 6A is a schematic view of a magnification pattern 408b of the magnification generation module 400 according to a second embodiment of the present invention, and FIG. 6B is a schematic view of a sensing unit 410b of the magnification generation module 400 shown in FIG. 6A. The magnification pattern 408b is disposed in the magnification adjustment module 406. The magnification pattern 408b is composed of a plurality of magnification sections 600 and the magnification pattern 408b contains a plurality of values of magnification. Each magnification section 600 corresponds to one of the values of magnification. The magnification pattern 408b and the magnification adjustment module 406 are set in synchronization with each other for operation thereof. In an embodiment, each magnification section 600 includes a plurality of light/shade areas 602. The magnification pattern 408b is composed of a disc-shaped layer of material.

In the embodiment of FIG. 6A, the magnification pattern 408b contains for example seven magnification sections respectively representing a value of magnification from 3× to 9×. Each magnification section 600 includes three light/shade areas 602. The light/shade areas are constructed with for example a printed circuit board (PCB) 606 having light-transmitting portions and non-light-transmitting portions, wherein the light-transmitting portion form the light areas and the non-light-transmitting portions form the shade areas. In FIG. 6B, the sensing unit 410b comprises a plurality of light detection elements 604a, 604b, 604c. Each light detection element 6041, 604b, 604c corresponds to a respective light/shade area 602 of each magnification section 600, whereby a magnification signal can be detected by these light detection elements 604a, 604b, 604c.

When light enters the sighting apparatus 200 and travels through the magnification pattern 408b, the light detection elements 604a, 604b, 604c respectively detect the light/shade areas 602 of one magnification section 600, whereby the sensing unit 410b can obtain the magnification signal through the light detection element 604a, 604b, 604c. Here, the sensing unit 410b contains for example three detection elements 604a, 604b, 604c to respectively detect three light/shade areas 602. In one embodiment, the magnification pattern 408b is constructed as a disc-shaped layer of material and the disk-shaped layer of material moves synchronously with the magnification adjustment ring 406. The disc-shaped material layer and the magnification adjustment ring 406 rotate about a common axis of rotation. Moreover, the three detection elements 604a, 604b, 604c may be for example adhesively attached to a detection circuit board 606, whereby when the magnification adjustment ring 406 is rotated, the detection circuit board 606 is moved relative to the magnification pattern 408b for respectively detecting the three light/shade areas 602.

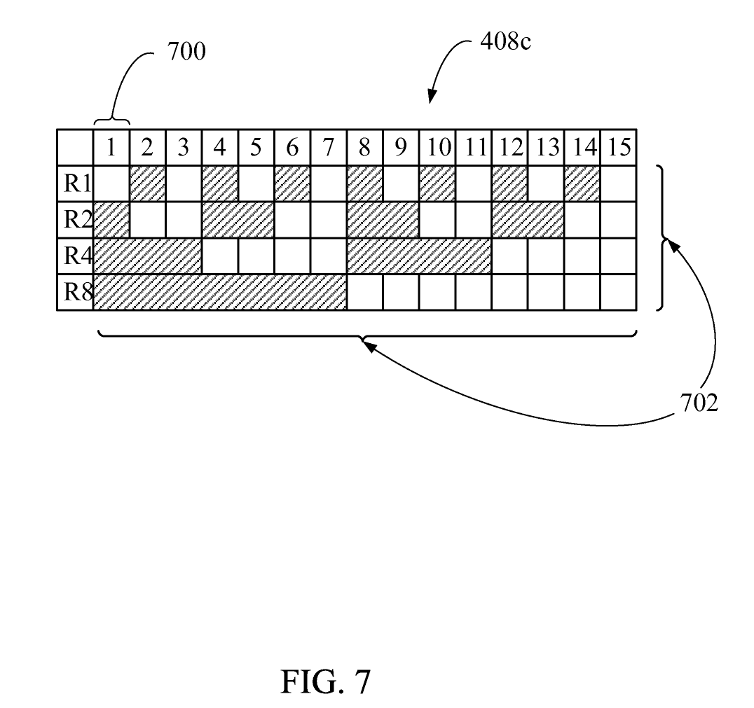

Referring to FIGS. 4 and 7, FIG. 7 is a schematic view of a magnification pattern 408c of the magnification generation module 400 according to a third embodiment of the present invention. The magnification pattern 408c is composed of a plurality of magnification sections 700 and the magnification pattern 408c contains a plurality of values of magnification. The magnification pattern 408c is similar to the magnification pattern 408b of FIG. 6A, and a difference resides in that the magnification pattern 408c is constructed as a rectangular layer 702 of material forming a circumferential ring of patterns. The pattern ring is arranged to for example encompass and attach to the magnification adjustment ring 406. The numbers of 1 to 15 on the horizontal axis of FIG. 7 represent the magnification values of the sighting apparatus 200. The labels of R1, R2, R3, R4 on the vertical axis of FIG. 7 indicate numbering of the light detection elements employed to detect the magnification pattern 408c. Blank squares in FIG. 7 represent the light areas, meaning being light transmittable to allow the light detection elements to obtain a signal, and shaded squares represent the shade areas, which are light non-transmittable and prevent the light detection elements from obtaining a signal. In one embodiment, the light/shade areas are constructed with for example a printed circuit board (PCB) having light-transmitting portions and non-light-transmitting portions. The magnification pattern 408c is disposed in the magnification adjustment module 406 and is set in synchronization with the magnification adjustment module 406 for the operation thereof.

Based on the above description, the sighting apparatus capable of displaying magnification as provided by the present invention comprises a magnification generation module that comprises a magnification pattern and a sensing unit. When the magnification adjustment module drives the magnification pattern to carry out adjustment, the sensing unit detects the magnification pattern to obtain the current value of magnification among those magnification values and generate a magnification signal corresponding to the current magnification value for immediately displaying the current magnification value in a field of vision of the sighting apparatus. In this way, the problem that the user must remove his or her eye from the field of vision of an existing sighting apparatus in order to get aware of the magnification value is completely overcome.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sighting apparatus comprising:
a magnification adjustment module, which is operated for adjusting magnification of the sighting apparatus;
a magnification generation module, which comprises a magnification pattern, which undergoes a movement in response to the operation of the magnification adjustment module, and a sensing unit, which detects the magnification pattern to obtain a current value of the magnification and generates a magnification signal corresponding to the current magnification value; and
a display unit, which displays the current magnification value corresponding to the magnification signal.

2. The sighting apparatus as claimed in claim 1, wherein the magnification pattern comprises a plurality of magnification sections, each corresponding to a value of the magnification.

3. The sighting apparatus as claimed in claim 2, wherein the magnification pattern and the magnification adjustment module synchronously movable with each other.

4. The sighting apparatus as claimed in claim 3, wherein the magnification adjustment module comprises a rotatable magnification adjustment ring.

5. The sighting apparatus as claimed in claim 2, wherein each of the magnification sections comprises a plurality of electrode zones.

6. The sighting apparatus as claimed in claim 5, wherein the sensing unit comprises a plurality of electrically conductive portions, which is in electrical engagement with respective electrode zones of the magnification sections so that the electrode zones detect the magnification signal.

7. The sighting apparatus as claimed in claim 5, wherein the magnification pattern comprises an electrically conductive ring.

8. The sighting apparatus as claimed in claim 2, wherein each of the magnification sections comprises a plurality of light/shade areas.

9. The sighting apparatus as claimed in claim 8, wherein the sensing unit comprises a plurality of light detection elements respectively corresponding to the light/shade areas of each magnification section so that the light detection elements detect the magnification signal.

10. The sighting apparatus as claimed in claim 9, wherein the magnification pattern comprises a disc-shaped layer of material.

11. The sighting apparatus as claimed in claim 9, wherein the magnification pattern comprises a rectangular layer of material forming a circumferential ring of pattern.

12. The sighting apparatus as claimed in claim 1 further comprising a controller coupled to the magnification generation module for transformation of the magnification signal.
